(19) United States
(12) Patent Application Publication
(10) Pub. No.: US 2025/0117957 A1
(43) Pub. Date: Apr. 10, 2025

(54) METHOD FOR CALCULATING LENGTH OF CRACK LINE BY USING CONTINUOUSLY CAPTURED IMAGES OF CRACK LINE IN BUILDING SUBJECT TO SAFETY DIAGNOSIS, AND WORKER TERMINAL HAVING INSTALLED THEREON PROGRAM FOR EXECUTING METHOD FOR CALCULATING LENGTH OF CRACK LINE BY USING CONTINUOUSLY CAPTURED IMAGES OF CRACK LINE IN BUILDING SUBJECT TO SAFETY DIAGNOSIS

(71) Applicant: HANSTYLE ENGINEERING CO., LTD., Seoul (KR)

(72) Inventor: Da Woon JEONG, Seoul (KR)

(21) Appl. No.: 18/567,357

(22) PCT Filed: Apr. 4, 2022
(86) PCT No.: PCT/KR2022/004770

§ 371 Date: Jan. 29, 2024

(30) Foreign Application Priority Data
Jun. 7, 2021 (KR) 10-2021-0073694

(51) Int. Cl. G06T 7/60; G06T 7/00

(52) U.S. Cl. CPC G06T 7/60; G06T 7/0002; G06T 2207/10016

(57) ABSTRACT

Provided are a method for computing a crack line length using continuous photographic images of a crack line in a safety assessment target building and a worker terminal installed with a program for executing the method for computing a crack line length using continuous photographic images of a crack line in a safety assessment target building. Provided is implemented through processes which are performed by the worker terminal and include: analyzing photographic images continuously captured while a worker moves along a crack line present in an inspection target area in a photographing space, which is a space where the worker performs photography, to generate shape information of the crack line; and computing a length of the crack line based on the shape information of the crack line.

### TECHNICAL FIELD

The present invention relates to a method for computing crack line lengths using continuous photographic images of a crack line in a safety assessment target building and a worker terminal installed with a program for executing the method for computing a crack line length using continuous photographic images of a crack line in a safety assessment target building, and more particularly, to a method for computing a crack line length using continuous photographic images of a crack line in a safety assessment target building, in which a worker terminal may analyze continuously captured close-up images of the crack line in an inspection target area to generate information on a shape of the crack line with great accuracy, and compute a length of the crack line based on shape information of the crack line generated as described to calculate the length of the crack line with great accuracy, and a worker terminal installed with a program for executing the method for computing a crack line length using continuous photographic images of a crack line in a safety assessment target building.

### BACKGROUND ART

Commonly, a worker who visits a safety assessment target building for performing a safety assessment due to aging of the building, such as an occurrence of cracks, moves around inside the corresponding building and take pictures an area where cracks have occurred, such as walls, columns, slabs, beams and the like.

As described above, the worker takes on-site pictures for each inspection target area of the building and then writes a building assessment report. During this process, the worker separately creates crack state drawings by referring to the pictures taken on the cracked area of the building.

As described above, it takes separate time and effort for the worker to create the crack state drawings. In addition, when the worker creates the crack state drawings by referring to the pictures taken on the cracked area such as the walls, columns, slabs, beams, and the like, the shape and size of the cracks may be expressed inaccurately, unlike their actual shape and size.

In addition, to perform safety diagnostic inspection of the building, an incidence of the cracks (i.e., a length of the crack line) should be measured and managed very accurately. However, conventionally, the work is carried out in a way that the worker creates the crack state drawings by referring to the pictures taken on the cracked area of the building, such that there is a problem that the length of the crack line cannot be accurately measured.

### SUMMARY OF INVENTION

### Problems to be Solved by Invention

Therefore, it is an object of the present invention to provide a method for computing a crack line length using continuous photographic images of a crack line in a safety assessment target building, in which a worker terminal may analyze continuously captured close-up images of the crack line in an inspection target area to generate information on a shape of the crack line with great accuracy, and compute a length of the crack line based on shape information of the crack line generated as described to calculate the length of the crack line with great accuracy, and a worker terminal installed with a program for executing the method for computing a crack line length using continuous photographic images of a crack line in a safety assessment target building.

### Means for Solving Problems

To achieve the above object, according to an aspect of the present invention, there is provided a method for computing a crack line length in a safety assessment target building including: (a) analyzing, by a worker terminal, photographic images continuously captured while a worker moves along a crack line present in an inspection target area in a photographing space, which is a space where the worker performs photography, to generate shape information of the crack line; and (b) computing, by the worker terminal, a length of the crack line based on the shape information of the crack line.

In addition, the method may further include, before the step (a), continuously measuring, by the worker terminal, a separation distance between the inspection target area and the worker terminal during continuously capturing images while moving along the crack line by the worker terminal.

In addition, the step (a) may include (a1) correcting, by the worker terminal, a size of the continuously captured image based on information of the continuously measured separation distance, wherein the worker terminal may calculate average separation distance information of the continuously measured separation distance information, and correct the size of the photographic image based on the calculated average separation distance information.

In addition, the step (a) may further include (a2) generating, by the worker terminal, shape information of the crack line based on position movement information of the worker terminal in a continuous capturing process.

In addition, the step (a) may further include (a2) generating, by the worker terminal, shape information of the crack line based on positional information on an object commonly included in a plurality of partially captured images generated in the continuous capturing process.

In addition, the step (b) may include: (b1) changing, by the worker terminal, a curved section included in the crack line into a straight section; and (b2) calculating, by the worker terminal, the length on the photographic image of the crack line based on length information of the straight section.

In addition, the step (b) may further include (b3) calculating, by the worker terminal, the actual length of the crack line based on scale information of the continuously captured image and length information on the photographic image of the crack line.

Further, there is provided a worker terminal including a program installed therein to execute the method for computing a crack line length in a safety assessment target building.

### Advantageous Effects

According to the present invention, the worker terminal may analyze continuously captured close-up images of the crack line in an inspection target area to generate information on a shape of the crack line with great accuracy, and compute a length of the crack line based on shape information of the crack line generated as described to calculate the length of the crack line with great accuracy.

### BRIEF DESCRIPTION OF DRAWINGS

FIG. 1 is a procedural flowchart describing execution processes of a method for computing a crack line length in a safety assessment target building according to an embodiment of the present invention.

FIGS. 2 to 4 are views illustrating screen statuses of a worker terminal in execution processes of the method for computing a crack line length in a safety assessment target building according to an embodiment of the present invention.

FIG. 5 is a procedural flowchart describing processes of computing the length of the crack line based on shape information of the crack line in the method for computing a crack line length in a safety assessment target building according to an embodiment of the present invention.

FIG. 6 is a procedural flowchart describing processes of obtaining scale information of the corrected photographic image in the method for computing a crack line length in a safety assessment target building according to an embodiment of the present invention.

### MODE FOR CARRYING OUT INVENTION

Hereinafter, the present invention will be described with reference to the accompanying drawings in detail. Referring to the drawings, like reference characters designate like or corresponding parts throughout the several views. In the embodiments of the present invention, the publicly known functions and configurations that are judged to make the purport of the present invention unnecessarily obscure will not be described.

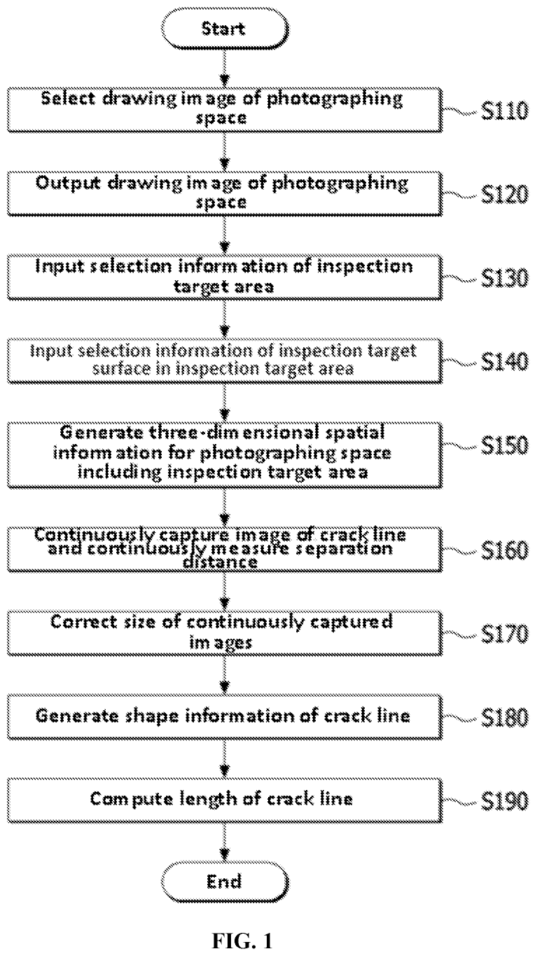

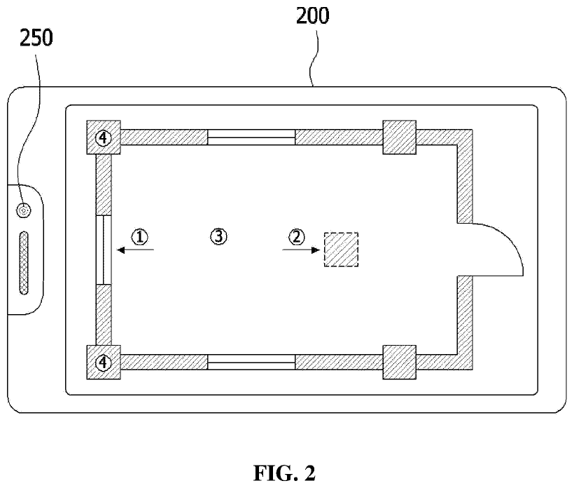

FIG. 1 is a procedural flowchart describing execution processes of a method for computing a crack line length in a safety assessment target building according to an embodiment of the present invention, and FIGS. 2 to 4 are views illustrating screen statuses of a worker terminal in execution processes of the method for computing a crack line length in a safety assessment target building according to an embodiment of the present invention.

Meanwhile, a worker terminal 200 in the present invention may be a wireless communication terminal such as a smartphone or tablet PC possessed by a worker who performs safety assessment of a building, and the worker terminal 200 may include an application program installed therein to execute the method for computing a crack line length in a safety assessment target building according to the present invention.

In addition, in carrying out the present invention, the worker terminal 200 is provided with a camera module 250 for capturing a close-up image of the crack lines in an inspection target area, a LIDAR sensor module for generating three-dimensional spatial information on a photographing space, and measuring a separation distance to a photographing target surface.

Hereinafter, execution processes of the method for computing a crack line length in a safety assessment target building according to an embodiment of the present invention will be described with reference to FIGS. 1 to 4.

First, a worker who visits a safety assessment target building for inspection due to aging of the building, such as an occurrence of cracks selects a plan view image file of a floor currently being diagnosed among the plan view image files for each floor of the corresponding building stored in the worker terminal 200 (S110).

Specifically, when the worker is conducting a safety assessment on the first floor of the corresponding building, the worker selects a plan view image file of the first floor among the plan view image files for each floor stored in the worker terminal 200, and thus the plan view image of the corresponding floor is output on a screen of the worker terminal 200 as shown in FIG. 2 (S120).

Thereafter, the worker who performs the safety assessment while moving around inside the corresponding floor checks the status of cracks in inspection target areas, such as walls, columns, slabs and beams, etc., and determines whether to capture an image of the corresponding inspection target area.

As such, when it is determined to capture an image of the inspection target area, the worker selects the inspection target area that has been determined to capture an image on the plan view image of the corresponding floor displayed on the screen of the worker terminal 200 in a manner of touching the screen, etc., as shown in FIG. 2 (S130).

Meanwhile, in carrying out the present invention, the worker can additionally input selection information of a specific inspection target surface in the inspection target area on the plan view image output on the screen of the worker terminal 200 in a manner of touching the screen, etc., (S140).

Specifically, when the inspection target area is a wall, the worker selects the corresponding wall on the plan view image output on the screen of the worker terminal 200 in a manner of touching the screen, etc. In this case, the worker may select the specific inspection target surface in the corresponding wall by distinguishing between the front and rear of the wall, or as shown in FIG. 2, may input selection information of the inspection target surface by executing a swipe motion \textcircled{1}, which is an operation of moving a finger toward the inspection target surface of the corresponding wall.

In addition, when the inspection target area is a pillar, the worker selects the corresponding pillar on the plan view image output on the screen of the worker terminal 200 in a manner of touching the screen, etc. In this case, if the corresponding pillar is a square pillar, the worker may select the inspection target surface by distinguishing between four sides of the pillar, or as shown in FIG. 2, input selection information of the inspection target surface by executing the swipe motion \textcircled{2}, which is an operation of moving the finger toward the inspection target surface on the corresponding pillar.

In addition, when the inspection target area is the slab, the worker performs an operation \textcircled{3} of pressing the corresponding slab with a finger on the plan view image output on the screen of the worker terminal 200 for a predetermined reference time (for example, 1 second) or more, thus to select the inspection target area. In this case, when pressing with one finger, an upper surface of the slab (i.e., a bottom surface) may be selected as the inspection target surface in the corresponding slab, and when pressing simultaneously with two or more fingers (multi-touch)), a lower surface of the slab (i.e., a ceiling surface of the lower floor) may be selected as the inspection target surface in the corresponding slab.

In addition, when the inspection target area is the beam, the worker performs an operation \textcircled{4} of pressing a pair of pillars respectively connected to left and right ends of the corresponding beam at the same time with each finger on the plan view image of the corresponding floor output on the screen of the worker terminal 200, thus to select the inspection target area. In this case, when pressing with one finger, the lower surface of the beam may be selected as the inspection target surface in the corresponding beam, when multi-touching with two fingers, the left side of the corresponding beam may be selected as the inspection target surface, and when multi-touching using three fingers, the right side of the corresponding beam may be selected as the inspection target surface.

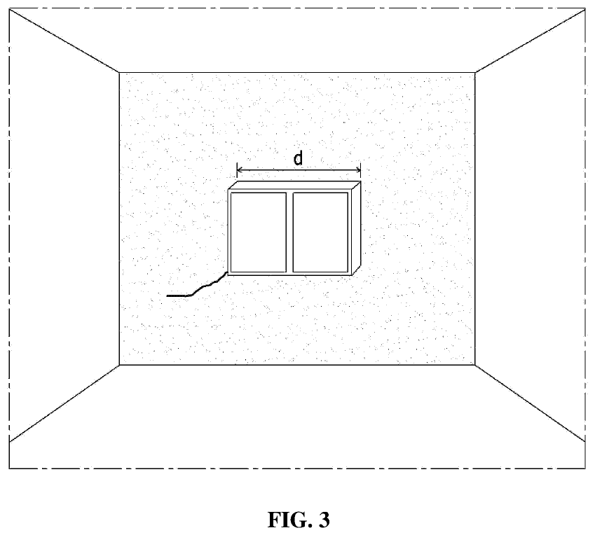

As such, before a worker who selects a inspection target area and a specific inspection target surface in the inspection target area captures a close-up image of the crack line on the inspection target surface using the camera module 250 provided in the worker terminal 200, the worker may generate three-dimensional spatial information on the photographing space including the inspection target area using the LIDAR sensor module provided in the worker terminal 200 as shown in FIG. 3 (S150).

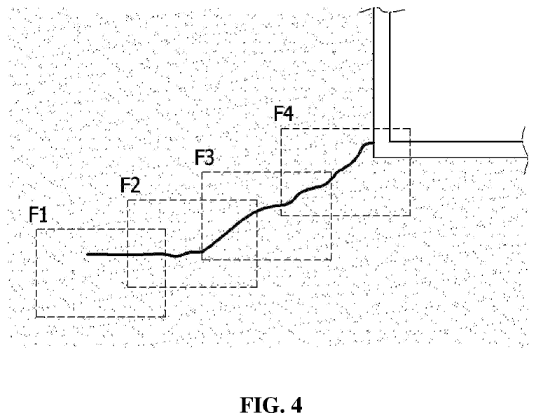

Then, the worker continuously captures close-up images of the crack line while continuously moving the camera module 250 of the worker terminal 200 from a start point of the crack line present in the inspection target area to an end point of the crack line as shown in FIG. 4 (S160).

Meanwhile, during performing continuous capturing images of the crack line, the LIDAR sensor module provided in the worker terminal 200 continuously measures a separation distance between the worker terminal 200 and the crack line (i.e., a separation distance to the inspection target surface, which is the photographing target surface, therefrom), and the worker terminal 200 stores information on each continuously measured separation distance in association with the image captured at the time of each separation distance measurement (S160).

As a result, as shown in FIG. 4, the worker terminal 200 stores partial photographic images obtained by continuously capturing images of the crack line and separation distance information corresponding to each partial photographic image.

Meanwhile, in carrying out the present invention, the worker may shoot a video while continuously moving the camera module 250 of the worker terminal 200 from the start point of the crack line to the end point of the crack line. In this case, the worker terminal 200 may extract a plurality of photographic images at a predetermined time interval among the continuously captured video frames as shown in FIG. 4, or extract a video image at the point when the worker checking the captured video through a screen of the worker terminal 200 during video shooting presses a frame selection button on the photographing screen.

In addition, in carrying out the present invention, a square frame for indicating a video region to be analyzed is displayed on the screen of the worker terminal 200, on which the captured video is output while the shooting is performed, and the worker continuously captures images of the crack line so that the crack line is included in the frame region. Then, the worker terminal 200 may analyze only the images within the corresponding frame region among the captured videos, thereby increasing the precision of the crack line shape analysis.

Meanwhile, the worker terminal 200 may correct the size of each partial photographic image based on information of the separation distance between the worker terminal 200 and the crack line at the time of capturing a partial photographic image of the crack line, which is stored in association with a plurality of partial photographic images as shown in FIG. 4 (S170).

Specifically, the worker terminal 200 may calculate an average value 1 of separation distances l1, l2, l3 and l4 in the respective partial photographic images F1, F2, F3 and F4, and increase the size of the corresponding partial photographic images by a ratio lᵢ/l of the calculated average value and each separation distance, thus to correct the size of each partial photographic image.

That is, as described above, in the present invention, the size of the crack line in each partial photographic image is corrected to be uniform by adjusting the size of each partial photographic image based on the same separation distance 1, such that the problem, in which the sizes of the crack line are different on the respective partial photographic images due to slightly changed separation distance between the worker terminal 200 and the crack line during continuously capturing images of the crack line, may be solved.

Meanwhile, the worker terminal 200 generates information on the shape of the crack line by analyzing each partial photographic image corrected so that the sizes of the crack line in each partial photographic image are uniform (S180).

Specifically, during continuously capturing images of the crack line in the above-described step S160, the worker terminal 200 may continuously measure changes in the coordinate value on the photographic surface of the worker terminal 200 due to continuously movement of the worker terminal 200 on the photographic surface, which is a plane parallel to the inspection target surface where the crack line is present, and the coordinate values of the worker terminal 200 at the time of capturing each partial photographic image of the crack line may be stored in association with each partial photographic image.

In this case, the worker terminal 200 may extract the shape of the crack line from each partial photographic image, and then place the extracted shape of each crack line according to coordinate value information stored in association with each partial photographic image, thereby generating shape information of an entire crack line.

In addition, in performing the above-described step S180, the worker terminal 200 may extract the shape of the crack line from each partial photographic image, and then place the shapes of the respective crack lines so that positions of objects such as nail marks, window frames, and picture frames which are commonly included in adjacent partial photographic images coincide with each other, thereby generating the shape information of the entire crack line.

As described above, according to the present invention, the worker terminal 200 may analyze continuous partial photographic images of the crack line in the inspection target area, thereby generating the shape information of the entire crack line with great precision.

Meanwhile, the worker terminal 200 computes the length of the crack line based on the shape information of the entire crack line generated as described above (S190).

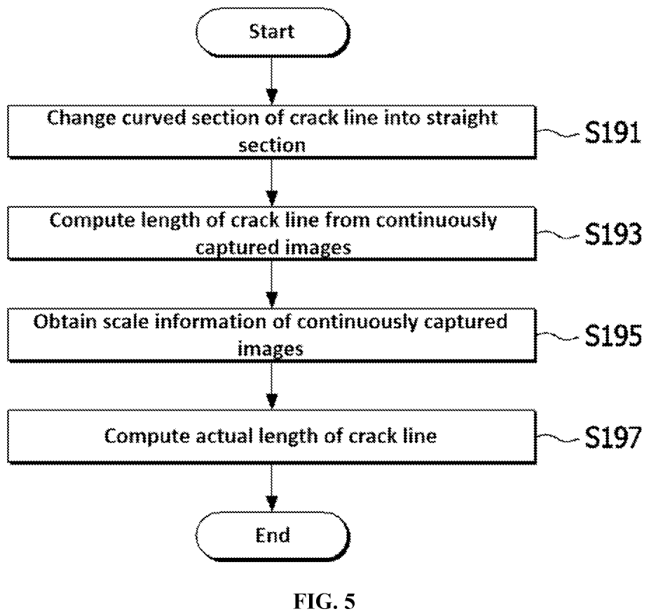

FIG. 5 is a procedural flowchart describing processes of computing the length of the crack line based on shape information of the crack line in the method for computing a crack line length in a safety assessment target building according to an embodiment of the present invention. Hereinafter, the processes of computing the length of the crack line based on the shape information of the crack line will be described with reference to FIG. 5.

First, the worker terminal 200 continuously analyzes the shape of the entire crack line in a direction in which the crack line is developed, thereby dividing the crack line into a straight section and a curved section, and then may change the curved section into a straight section connecting the start point and end point of the corresponding curved section (S191).

Next, the worker terminal 200 may compute the lengths of each straight section constituting the crack line, and sum the lengths of each straight section to calculate a total length of the crack line (S193).

Meanwhile, the worker terminal 200 may obtain scale information of the size-corrected photographic image in the above-described step S170 in order to convert the length on the photographic image of the crack line calculated as described above into the actual length of the crack line (S195).

In addition, in carrying out the present invention, the worker terminal 200 may perform the procedure for obtaining the scale information of the corrected photographic image after correcting the photographic image in the above-described step S170.

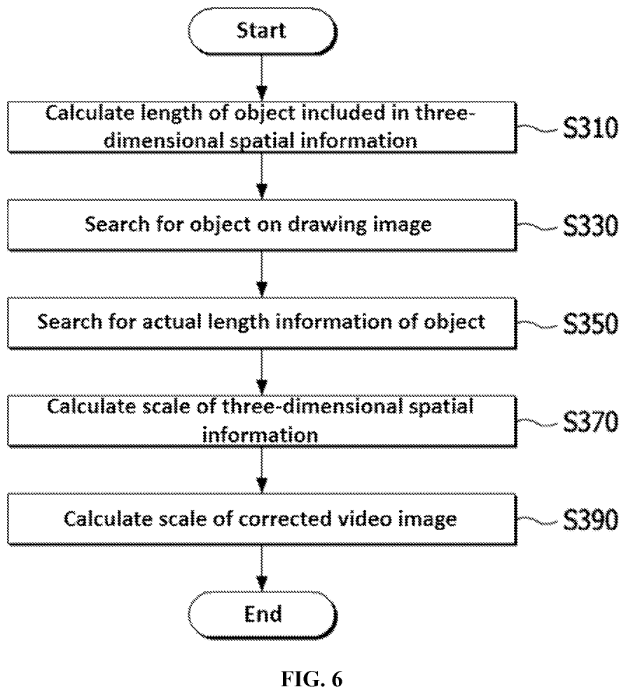

FIG. 6 is a procedural flowchart describing processes of obtaining scale information of the corrected photographic image in the method for computing a crack line length in a safety assessment target building according to an embodiment of the present invention. Hereinafter, the processes of obtaining scale information from the corrected photographic image will be described with reference to FIG. 6.

First, the worker terminal 200 calculates a straight line length d such as a horizontal width on the three-dimensional spatial information of an object such as a window frame included in the three-dimensional spatial information generated as shown in FIG. 3 in the above-described step S150 (S310).

Next, the worker terminal 200 searches for the same object such as the window frame on the drawing image of the photographing space in the above-described step S120 based on the shape information of the object on the three-dimensional spatial information (S330), and then may search for information of an actual straight line length D such as the horizontal width of the corresponding object, which is stored in the worker terminal 200 together with the drawing image (S350).

Accordingly, the worker terminal 200 may calculate scale information d/D of the three-dimensional spatial information based on the straight line length d such as the horizontal width on the three-dimensional spatial information of the object calculated in the above-described step S310 and the actual straight line length D such as the horizontal width of the object searched in the above-described step S350 (S370).

Meanwhile, in carrying out the present invention, when the worker terminal 200 calculates a first scale value S1, as the three-dimensional spatial information generated as shown in FIG. 3 in the above-described step S150 is output on the screen of the worker terminal 200, the worker may draw a straight line connecting two arbitrary points (e.g., one edge point of a wall and the other edge point opposite thereto, a top point and a bottom point of a pillar, one end of a window frame and the other end of a window frame, etc.) on the three-dimensional spatial information in a touch & drag manner on the screen of the worker terminal 200.

Accordingly, the worker terminal 200 calculates the length d of the corresponding straight line drawn by the worker on the screen of the worker terminal 200, and then when the actual straight line length D in the photographing space of a portion corresponding to the straight line is input into the worker terminal 200 by the worker, the worker terminal 200 may calculate a scale d/D of the three-dimensional spatial information calculated based on the same as the first scale value S1.

Next, based on the separation distance L to the inspection target surface where the object such as a window frame is present measured by the LIDAR sensor module provided in the worker terminal 200 at the time of generating the three-dimensional spatial information in step S150, and an average separation distance 1 which is an average value of respective separation distance information l1, l2, l3 and l4 in respective partial photographic images F1, F2, F3 and F4 in the above-described step S170, the worker terminal 200 may calculate a second scale value S2, which is a scale value of the size-corrected photographic image, according to Equation 1 below.

$$S 2 = S 1 * L / 1 \qquad [ Equation 1 ]$$

In addition, the worker terminal 200 that has calculated the second scale value S2 as described above may apply the second scale value S2 to a length m on the size-corrected photographic image of the crack line calculated in the above-described step S193, thereby computing an actual length M of the crack line according to Equation 2 below (S390).

$$M = m \div S 2 \qquad [ Equation 2 ]$$

According to the present invention, the worker terminal analyzes the continuously captured close-up images of the crack line in the inspection target area, and may compute the length of the crack line based on the shape information of the crack line generated as described to calculate the length of the crack line with great accuracy.

Meanwhile, in carrying out the present invention, the worker captures an image of the inspection target area through the worker terminal 200 after executing the above-described step S140 and before executing the above-mentioned step S150, and the worker terminal 200 may generate a development diagram (for example, an elevation view of the wall, etc.) of the inspection target area based on the photographic image of the inspection target area.

In carrying out the present invention, when the inspection target area is a wall, the worker terminal 200 may generate a development diagram of the wall in the above-described step S160 based on numerical information such as the width and length of the corresponding wall stored together with the plan view selected by the worker in the above-described step S110, thereby increasing the accuracy of the development diagram creation work.

Meanwhile, the worker terminal 200 may perform overlapping the actual length information of the crack line calculated according to Equation 2 above with the shape information of the entire crack line in the development diagram of the inspection target surface generated as described above, thereby generating a crack state development diagram for the inspection target area.

Terms used in the present invention are used only to describe specific embodiments, and are not intended to limit the present invention. Singular expressions used herein include plural expressions unless they have definitely opposite meanings in the context. In the present application, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

While the present invention has been described with reference to the preferred embodiments and modified examples, the present invention is not limited to the above-described specific embodiments and the modified examples, and it will be understood by those skilled in the art that various modifications and variations may be made therein without departing from the scope of the present invention as defined by the appended claims, as well as these modifications and variations should not be understood separately from the technical idea and prospect of the present invention.

### INDUSTRIAL APPLICABILITY

The present invention may be applied to the technical field related to safety assessment of buildings, such that industrial applicability thereof is recognized.

1. A method for computing a crack line length in a safety assessment target building comprising:
(a) analyzing, by a worker terminal, photographic images continuously captured while a worker moves along a crack line present in an inspection target area in a photographing space, which is a space where the worker performs photography, to generate shape information of the crack line; and
(b) computing, by the worker terminal, a length of the crack line based on the shape information of the crack line.

2. The method for computing a crack line length in a safety assessment target building according to claim 1, further comprising, before the step (a),
continuously measuring, by the worker terminal, a separation distance between the worker terminal and the inspection target area while moving along the crack line and continuously capturing images by the worker terminal.

3. A worker terminal comprising a program installed therein to execute the method for computing a crack line length in a safety assessment target building according to claim 1.

4. A worker terminal comprising a program installed therein to execute the method for computing a crack line length in a safety assessment target building according to claim 2.
